(19) United States
(12) Patent Application Publication
(10) Pub. No.: US 2011/0157642 A1
(43) Pub. Date: Jun. 30, 2011

(54) PRINTING APPARATUS, METHOD FOR CONTROLLING PRINTING APPARATUS, AND STORAGE MEDIUM

(75) Inventor: Junko Nemoto, Tokyo (JP)

(73) Assignee: CANON KABUSHIKI KAISHA, Tokyo (JP)

(21) Appl. No.: 12/972,257

(22) Filed: Dec. 17, 2010

(30) Foreign Application Priority Data
Dec. 26, 2009 (JP) 2009-296515

(51) Int. Cl. G06F 3/12

(52) U.S. Cl. 358/1.15

(57) ABSTRACT

A user can easily recognize a settable post-processing position when the user selects settings of post-processing to be performed on document information in a general-purpose file format. The present invention provides a control method for controlling a printing apparatus to which a post-processing apparatus for performing post-processing on a printed sheet is connectable. The control method includes storing, into a storage unit, document information of which file format is a predetermined file format, generating an image corresponding to the document information by analyzing the stored document information, determining a size of the sheet on which the image is printed, obtaining a capability of the post-processing apparatus, and displaying a settable post-processing position on a display unit according to the determined size of the sheet, and the obtained capability of the post-processing apparatus.

### BACKGROUND OF THE INVENTION

1. Field of the Invention

The present invention relates to a printing apparatus, a method for controlling a printing apparatus, and a storage medium.

2. Description of the Related Art

Currently, some image forming apparatuses (or printing apparatuses) are equipped with the function of printing or transmitting document information stored in a hard disk drive (HDD) of the image forming apparatus in response to an operation of an operation unit of the image forming apparatus. This function is called “box function”. In printing with use of this function, a user can specify, through an operation unit, layout settings including a reduction layout such as the 2-in-1 or 4-in-1 layout, and finishing settings such as stapling and punching according to the capability of the mounted post-processing apparatus (finisher). However, the settable staple position and punch position are limited depending on the capability of the finisher (post-processing apparatus) connected to an image forming apparatus. Especially, there is a plurality of types of finishers, and various limits exist according to the capability of a finisher, the size of a paper to be used, and an image orientation. Therefore, when a user performs print settings merely by selecting one of options such as the upper right, lower right, upper left, or lower left of an image, the finishing processing may be performed in a different way from the user's intention, or sometimes no finishing processing may be applied, depending on the set contents. Further, there is even the print setting for dynamically changing the orientation of an image to be printed according to the number of images to be allocated on one sheet, such as a reduction layout. Therefore, the user should exercise great care to perform print settings, imagining the output result.

Following methods has been discussed to solve these problems. In the first method, an apparatus stores a preview of a finishing layout for each print condition in advance, thereby reading out the preview of the finishing layout corresponding to the print condition specified by a user, and applying a correction to the read-out finishing layout according to a user's specification such as a paper type (for example, refer to Japanese Patent Application Laid-Open No. 2000-227849). In the second method, there is a printing apparatus capable of generating and displaying a preview image based on document information according to print settings, and allowing a user to change predetermined items such as finishing settings within the range of the print settings at that moment (for example, refer to Japanese Patent Application Laid-Open No. 2006-11847).

On the other hand, aside from the above-mentioned techniques, recently, files in the general-purpose formats such as the Portable Digital Format (PDF) format and the XML Paper Specification (XPS) format has been used. However, when a document information in a general-purpose format such as the PDF format and XPS format is stored in an HDD thereafter the document information is printed, a user cannot recognize the image size and the orientation of the print target document. Therefore, in the above-mentioned techniques a user cannot determine the corresponding finishing layout, and thereby printing apparatus cannot present correct post-processing settings to a user. The Portable Document Format (abbreviated as “PDF”) format is a file format with respect to electronic documents, which was developed and has been proposed by Adobe Systems Incorporated. The XML Paper Specification (XPS) format is a file format for electronic files with a fixed layout, which enables file sharing while maintaining the document format. Both of them are an example of general-purpose file formats.

For example, in the method discussed in Japanese Patent Application Laid-Open No. 2000-227849, it is possible to determine a finishing layout corresponding to a specified print condition since the image size and the image orientation of a print target document is known. Therefore, it is possible to present a finishing preview to a user. In addition, the method discussed in Japanese Patent Application Laid-Open No. 2006-11847 can also determine the image size and image orientation of a print target document since it generates a preview image. However, both of these methods cannot provide a preview for document information in a general-purpose file format. Further, a preview image is regenerated after a user instructs a change in print settings, thereby resulting in deterioration of the performance of print setting change and reduction in the usability.

### SUMMARY OF THE INVENTION

According to an aspect of the present invention, a printing apparatus, to which a post-processing apparatus for performing post-processing on a printed sheet is connectable, includes a storage unit configured to store document information of which file format is a predetermined file format, a generating unit configured to generate an image corresponding to the document information by analyzing the document information stored in the storage unit, a determining unit configured to determine a size of the sheet on which the image is printed, an obtaining unit configured to obtain a capability of the post-processing apparatus, and a control unit configured to display a settable post-processing position on a display unit according to the size of the sheet determined by the determining unit, and the capability of the post-processing apparatus obtained by the obtaining unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating the configuration of an image forming apparatus.

FIG. 2 is a cross-sectional view illustrating the configuration of an engine of a multi function peripheral (MFP).

FIG. 3 is a flowchart illustrating a data processing procedure performed by the image forming apparatus.

FIG. 4 illustrates an example of an image data management table managed in an HDD.

FIG. 5 is a flowchart illustrating a data processing procedure performed by the image forming apparatus.

FIG. 6 illustrates an example of information regarding the capability of a finisher unit 126.

FIG. 7 illustrates an example of an image preview generated by the image forming apparatus.

FIG. 8 is a flowchart illustrating a data processing procedure performed by the image forming apparatus.

FIGS. 9A, 9B, and 9C illustrate examples of a user interface of the image forming apparatus, respectively.

### DESCRIPTION OF THE EMBODIMENTS

Various exemplary embodiments, features, and aspects of the invention will be described in detail below with reference to the drawings.

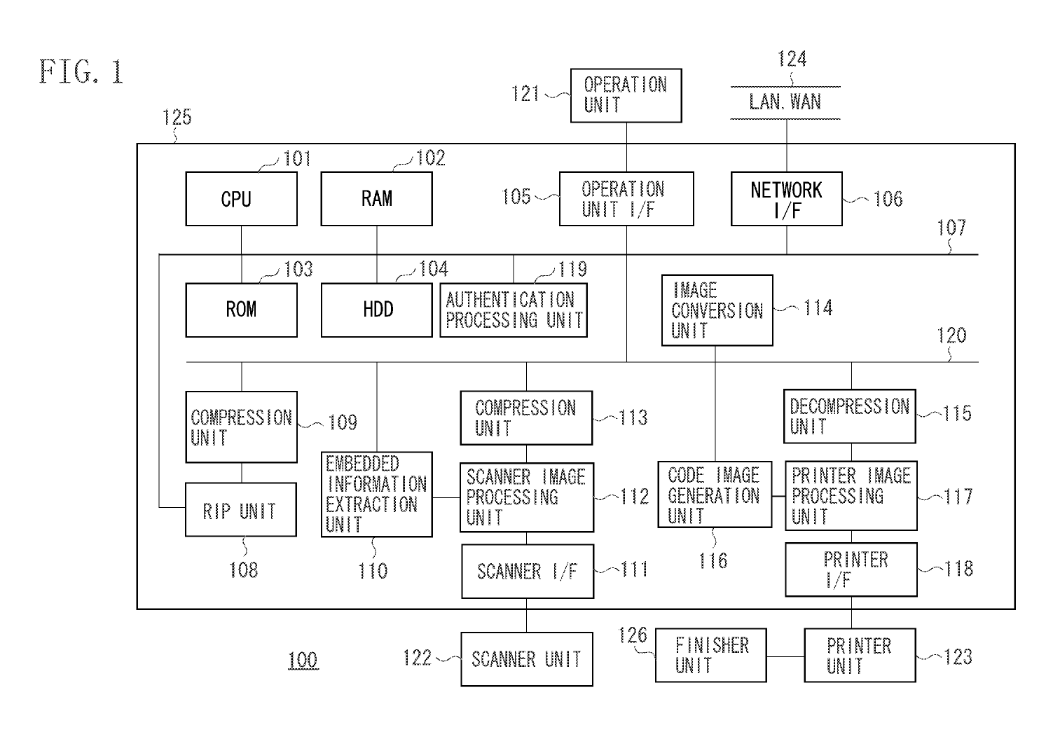

FIG. 1 is a block diagram illustrating the configuration of an image forming apparatus according to a present exemplary embodiment. The present example is constituted by an image forming apparatus provided with the function of storing and managing a print job received via a network, such as a multi function peripheral (MFP) 100. Referring to FIG. 1, a central processing unit (CPU) 101 comprehensively controls accesses to various units connected to a system bus 107 according to a control program stored in a read-only memory (ROM) 103 or an HDD 104. Further, the CPU 101 also comprehensively controls various kinds of processing performed in a controller 125.

A random access memory (RAM) 102 is a system work memory for use in an operation of the CPU 101, and is also a memory for temporarily storing image data. The ROM 103 stores, for example, a boot program of the apparatus. The HDD 104 (storage unit) can store system software, image data, and a document file in a general-purpose file format such as the PDF format and the XPS format. An operation unit interface (I/F) 105 is an interface unit for a connection between the system bus 107 and an operation unit 121. The operation unit I/F 105 receives image data to be displayed on the operation unit 121 (which also functions as a display unit) from the system bus 107 and outputs it to the operation unit 121, and also outputs information received via the operation unit 121 to the system bus 107.

A network I/F 106 is connected to a local area network (LAN) or wide area network (WAN) 124 and the system bus 107, and handles bidirectional exchanges of data between the MFP 100 and another apparatus. An image bus 120 is a transmission path for exchanging image data, and is constituted by a peripheral component interconnect (PCI) bus or Institute of Electrical and Electronic Engineers (IEEE) 1394. A scanner image processing unit 112 performs correction, processing, and edit on image data received from a scanner unit 122 through a scanner I/F 111. An embedded information extracting unit 110 detects a pattern and extracts additional information embedded in a background image from image data. A compression unit 113 receives image data and compresses the image data. A decompression unit 115 rasterizes data after decompressing it, and transmits the rasterized data to a printer image processing unit 117. The printer image processing unit 117 receives the image data transmitted from the decompression unit 115, and applies image processing on the image data by referring to attribute data accompanying the image data.

Further, code image data generated by a code image generation unit 116 is combined with image data if an instruction therefor is issued. The code image generation unit 116 generates code image data such as a two-dimensional code image, a barcode image, and an image generated by the information embedding technique. Generation of a code image is realized by execution of a program stored in the RAM 102. After the image processing is performed, image data is output to a printer unit 123 via a printer I/F 118. An image conversion unit 114 applies predetermined conversion processing such as rotation, color space conversion, binary-to-multivalued conversion, image combining, and thinning to image data. A raster image processor (RIP) unit 108 receives intermediate data generated based on page description language (PDL) code data, and generates bitmap data (multivalued data). The generated bitmap data is compressed by a compression unit 109 and then is transmitted to the image bus 120. An authentication processing unit 119 authenticates a user and a workgroup using user information input at the operation unit 121, and in addition, performs print job authentication. Further, the authentication processing unit 119 manages information of authenticated users and workgroups. A finisher unit 126 can be connected to the image forming apparatus, and performs various kinds of post-processing such as stapling processing, punching processing, and sorting processing on a sheet bundle formed by stacking a plurality of sheets discharged from the printer unit 123.

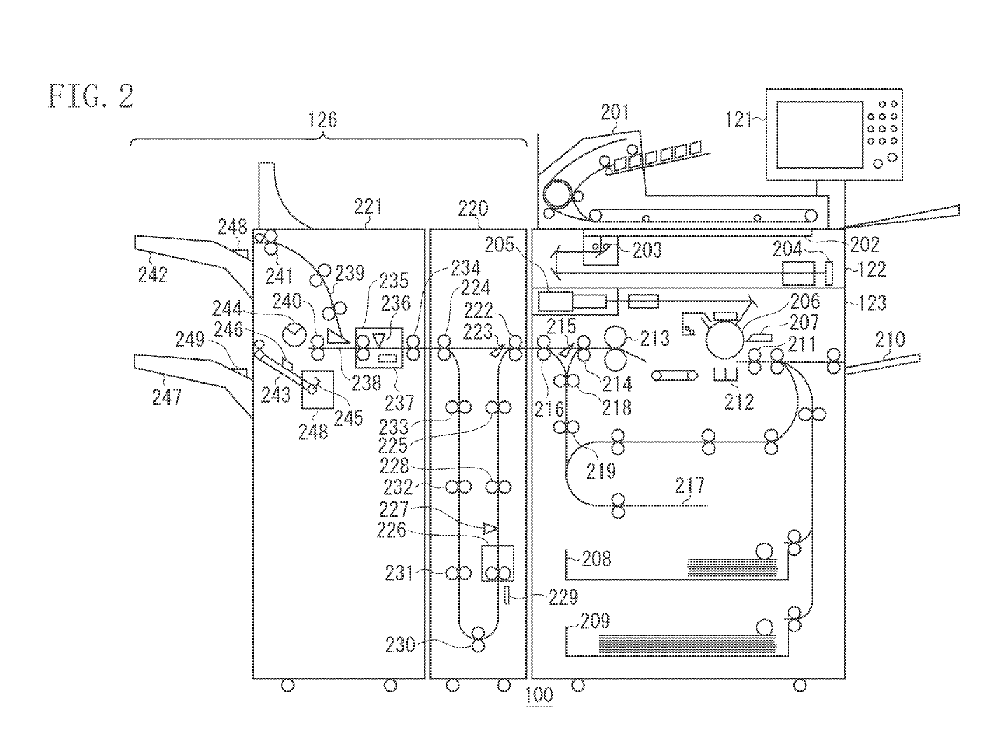

FIG. 2 is a cross-sectional view illustrating the configuration of the engine of the MFP 100 illustrated in FIG. 1. Referring to FIG. 2, the MFP 100 includes the scanner unit 122, the printer unit 123, the finisher unit 126, and the operation unit 121. The scanner unit 122 and the printer unit 123 are integrally constituted. Further, the finisher unit 126 is configured to be detachable to the printer unit 123. A document feeding apparatus 201 is mounted on the scanner unit 122. The document feeding apparatus 201 feeds documents face up, which are set on a document tray, in the left direction one by one sequentially, starting from the first page. Then, the document feeding apparatus 201 conveys the documents to a predetermined position on a platen glass 202 through a curved path.

Each of the documents conveyed to the predetermined position on the platen glass 202 is scanned by the scanner unit 203 from the left to the right thereof so that the image on the document is readout. When the scanner unit 203 scans a document, a surface of the document to be read out is irradiated with the light of a lamp of the scanner unit 203, and the reflected light from the document is guided to a lens through a mirror. The light, which has passed through this lens, forms an optical image on an imaging plane of an image sensor 204. This optical image is converted by the image sensor 204 into image data, and is output. The image data output from the image sensor 204 is input into an exposure control unit 205 of the printer unit 123 as a video signal, after predetermined processing is applied to the image data by the scanner image processing unit 112.

Next, image formation on one side of a sheet will be described. The exposure control unit 205 of the printer unit 123 modulates and outputs laser light based on the input video signal. Irradiation of the laser light is applied onto a photosensitive drum 206 while a polygonal mirror (not-shown) for example is scanning with the laser light. An electrostatic latent image is formed on the photosensitive drum 206 according to the scanning laser light. This electrostatic latent image formed on the photosensitive drum 206 is converted into a visible image as a developed image by a developer supplied from a development unit 207. Further, a sheet is fed from cassettes 208 and 209 or a manual feeding tray 210. This fed sheet stops after the leading edge thereof abuts on a registration roller 211, and the sheet is conveyed between the photosensitive drum 206 and a transfer unit 212 in synchronization with a start of the laser light radiation. The skew state of the sheet can be corrected owing to the stop of the sheet after the leading edge thereof abuts on the registration roller 211.

Then, the developed image formed on the photosensitive drum 206 is transferred onto the fed sheet by the transfer unit 212. The sheet with the developed image transferred thereon is conveyed to a fixing unit 213. The fixing unit 213 causes the developed image to be fixed on the sheet by hot-pressing the sheet. The sheet, which has passed through the fixing unit 213, is conveyed toward a flapper 215 by a conveyance roller 214, and is then conveyed toward a discharge roller 216 by the flapper 215. After that, the sheet is discharged from the printer unit 123 to the finisher unit 126 via the discharge roller 216. At this time, the sheet is discharged face up.

Alternatively, it is possible to discharge the sheet face down to the finisher unit 126. When the sheet is discharged face down, the flapper 215 is switched so that the sheet, which has passed through the fixing unit 213, is guided to an inverse conveyance path 217, and therefore the sheet is conveyed into the inverse conveyance path 217 via the flapper 215 with the aid of conveyance rollers 218 and 219. Then, the sheet conveyed to the inverse conveyance path 217 is switched back, whereby the front side and back side of the sheet are reversed. The sheet, the front and back of which have been reversed, is discharged from the printer unit 123 to the finisher unit 126 via the discharge roller 216.

The finisher unit 126 includes a first punch unit 220 and a staple stacker unit 221, and can perform various kinds of post-processing such as stapling processing, punching processing, and sorting processing on a sheet bundle formed by stacking a plurality of sheets with use of the units 220 and 221. The first punch unit 220 is a unit for performing multi-holes punch processing. The first punch unit 220 includes an inlet conveyance roller 222 for receiving the sheet discharged from the printer unit 123 into the first punch unit 220. The sheet conveyed into the first punch unit 220 is conveyed toward a discharge roller 224 or a conveyance roller 225 according to a switching operation of a flapper 223.

The sheet is conveyed toward the discharge roller 224 by the flapper 223 when the sheet is directly conveyed to the staple stacker unit 221 without being processed by the first punch unit 220. On the other hand, the sheet is conveyed toward the conveyance roller 225 by the flapper 223 when multi-holes punching processing is applied to the sheet. A conveyance roller 226, a sensor 227, a punch unit 228, and an abutting plate 229 are disposed at the downstream side of the conveyance roller 225. The sensor 227 is a sensor for detecting the leading edge of the sheet. The punch unit 228 performs multi-holes punching processing to form a large number of holes, for example, 30 holes at the leading edge of the sheet (the part of the sheet which becomes the head in the sheet conveyance direction). The abutting plate 229 is normally disposed at such a position that the sheet conveyance path is opened. The abutting plate 229 is rotated by π/2 (rad) degrees at predetermined timing so as to protrude into the sheet conveyance path for enabling the leading edge of the sheet to abut against the abutting plate 229.

This abutment of the leading edge of the sheet against the abutting plate 229 enables the sheet to be positioned relative to the punch unit 228 with predetermined accuracy. Conveyance rollers 230 to 233 are disposed at the downstream side of the abutting plate 229, and the conveyance path for guiding the sheet to the discharge roller 224 is formed by the conveyance rollers 230 to 233. The staple stacker unit 221 includes an inlet roller 234 for receiving the sheet discharged from the first punch unit 220 into the staple stacker unit 221. The sheet conveyed into the staple stacker unit 221 via the inlet roller 234 is guided into a second punch unit 235.

The second punch unit 235 performs several-holes punching processing for forming a small number of holes, such as 2 to 4 holes at the trailing edge of the sheet (the part of the sheet which becomes the trailing edge in the sheet conveyance direction) when the several-holes punching processing is set. On the other hand, the second punch unit 235 operates to convey the sheet to the downstream side without applying any processing to the sheet when the several-holes punching processing is not set. The second punch unit 235 contains a sensor 236 for detecting the trailing edge of the sheet, and an abutting plate 237 on which the trailing edge of the sheet abuts. When the second punch unit 235 performs the several-holes punching processing, a conveyance roller in the second punch unit 235 is rotated in the reverse direction at predetermined timing after the sensor 236 detects the trailing edge of the sheet.

Further, the abutting plate 237 is rotated by π/2 (rad) degrees so as to protrude into the sheet conveyance path. The sheet is switched back toward the abutting plate 237, and is stopped with the trailing edge thereof abutting on the abutting plate 237. While the sheet is positioned based on the trailing edge of the sheet in this way, a small number of holes are formed through the trailing edge of the sheet. After that, the sheet is conveyed toward a flapper 238 by the above-mentioned conveyance roller. The flapper 238 functions to switch the conveyance path to guide the sheet toward a non-sort path 239 or a conveyance roller 240. When post-processing such as sorting processing, punching processing and stapling processing is not set and the sheet is discharged without any post-processing applied thereto, the sheet is guided to the non-sort path 239 by the flapper 238.

The sheet guided to the non-sort path 239 is discharged onto a stack tray 242 by a conveyance roller 241. When post-processing such as sorting processing and stapling processing is set to the sheet, the printer unit 123 discharges the sheet face down to the finisher unit 126. Then, the sheet conveyed to the finisher unit 126 is conveyed to the staple stacker unit 221 through the first punch unit 220, and after that, is guided to the conveyance roller 240 by the flapper 238. Subsequently, the sheet is discharged onto a sheet bundle discharge belt 243 by the conveyance roller 240. A not-shown low frictional intermediate processing tray is disposed several millimeters above the sheet bundle discharge belt 243 in a manner extending in parallel with the sheet stack discharge belt 243, and actually, sheets are discharged onto the intermediate processing tray. The discharged sheets are moved downward to the right along the intermediate processing tray (sheet bundle discharge belt 243) under their own weight.

Further, a fan-shaped return roller 244 rotates in the counterclockwise direction, causing a frictional member disposed on the outer edge of the roller 244 to abut on the sheets. This abutment of the frictional member results in application of a force onto the sheets so as to drop the sheets downward to the right, thereby making the ends of the sheets abut on a stopper plate 245. This mechanism can align the sheets in the vertical direction (conveyance direction) of the sheets. Further, alignment plates 246 are disposed on the intermediate processing tray so as to be positioned at the front side and the rear side of the intermediate processing tray, respectively. The alignment plates 246 are driven each time a sheet is discharged onto the intermediate processing tray. Due to the alignment plates 246, the sheets can be aligned in the lateral direction (the width direction) of the sheets on the intermediate processing tray.

Then, when a predetermined number of sheets are discharged and stacked on the intermediate processing tray, the paper bundle discharge belt 243 is driven so that the sheets are discharged onto the stack tray 242 or 247. If the stapling mode is set, sheets of the number corresponding to one bundle for stapling are discharged onto the intermediate processing tray, and the sheets are aligned in the lateral direction of the sheets with the aid of the alignment plates 246. After that, the stapling unit 248 is driven to staple the sheet bundle, and the stapled sheet bundle is discharged onto the stack tray 242 or 247 by the paper stack discharge belt 243. The stack trays 242 and 247 are configured to be vertically movable. Further, sensors 248 and 249 for detecting presence of a sheet are disposed on the stack trays 242 and 247, respectively. Further, the stapling unit 248 can apply “corner staple”, i.e., stapling the rear-side position at the trailing edge of the sheets, and “double staple”, i.e., stapling two positions at the trailing edge of the sheets. A user sets at which position(s) of the sheets stapling is applied. The image forming apparatus may be embodied by a color image forming apparatus or a monochrome image forming apparatus. The present exemplary embodiment is described, assuming that the image forming apparatus is an electrophotographic image forming apparatus, but the image forming apparatus may be embodied by an ink-jet printing image forming apparatus.

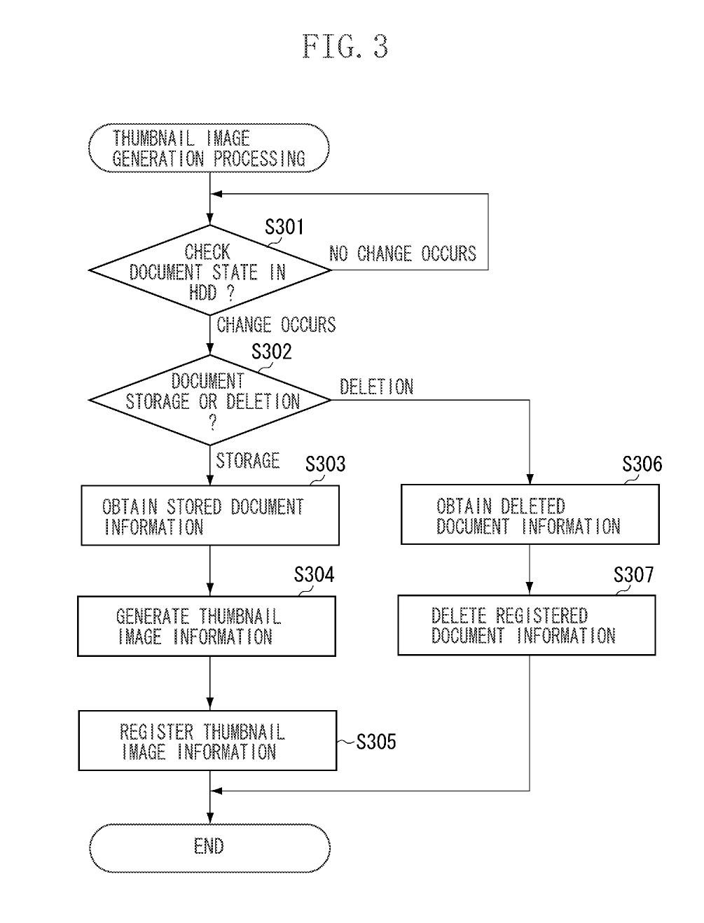

FIG. 3 is a flowchart illustrating an example of a data processing procedure performed by the image forming apparatus according to the present exemplary embodiment. This is an example of processing for generating an preview image (hereinafter referred to as “thumbnail image”) in the MFP 100. This processing includes steps S301 to S307. The CPU 101 loads the control program to the RAM 102 and executes it to realize steps S301 to S307. First, in step S301, the CPU 101 checks the state of document information (document) stored in the HDD 104. If the CPU 101 determines in step S301 that no change occurs in the document information in the HDD 104 (NO CHANGE OCCURS in step S301), step S301 is repeated until the CPU 101 detects occurrence of a change in the state of the document information. On the other hand, if the CPU 101 detects in step S301 that a change occurs in the state of the document information (CHANGE OCCURS in step S301), the processing proceeds to step S302. In step S302, the CPU 101 determines which has been carried out, storage of document information or deletion of document information. If the CPU 101 determines in step S302 that the change in the state of the document information is caused by storage of new document information (STORAGE in step S302), the processing proceeds to step S303 in which the CPU 101 obtains the document information stored in the HDD 104, and issues an image generation request to the printer image processing unit 117 based on the obtained document information.

Then, in step S304, the printer image processing unit 117 generates, on the RAM 102, a thumbnail image of the document information obtained by the CPU 101 from the HDD 104. More specifically, the printer image processing unit 117 interprets the obtained document information with use of a not-shown interpreter, and rasterizes it on the RAM 102, thereby generating the thumbnail image. At this time, the interpreter analyzes the page header and the file header, whereby the printer image processing unit 117 can obtain page information including, for example, the number of pages, the page size of the image, the image orientation, and the sheet size contained in the document information.

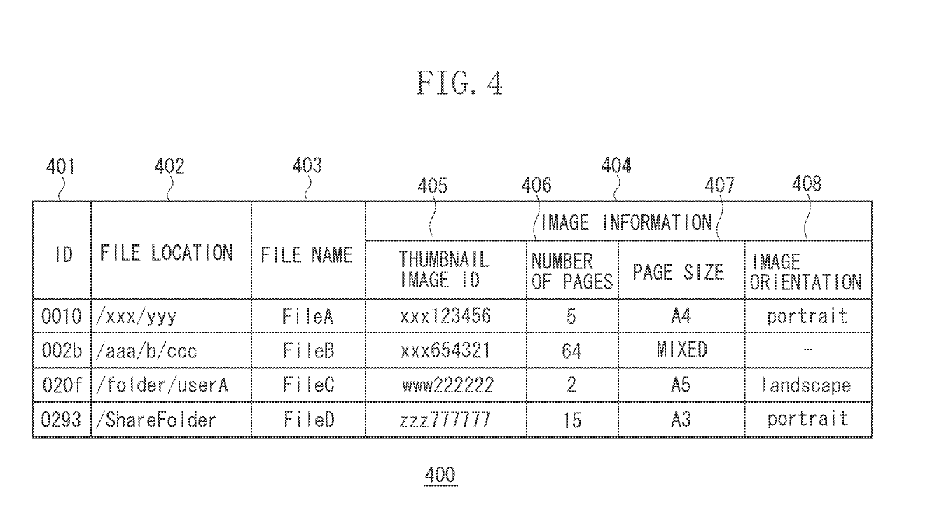

After the thumbnail image generation is completed in this way, the processing proceeds to step S305 in which the CPU 101 obtains the thumbnail image information and the page information of the document information from the printer image processing unit 117. Then, the CPU 101 registers the generated thumbnail image information in an image data management table 400 in FIG. 4, and ends the present processing. On the other hand, if the CPU 101 determines in step S302 that the change in the state of the document information is caused by deletion of document information (DELETION in step S302), the processing proceeds to step S306 in which the CPU 101 obtains the document information deleted from the HDD 104. Then, in step S307, the CPU 101 deletes the thumbnail image and the image information registered in the image data management table 400, and ends the present processing.

FIG. 4 illustrates an example of the image data management table managed in the HDD 104 in FIG. 1. In the present exemplary embodiment, image data stored in the HDD 104 or deleted from the HDD 104 is managed based on an ID 401, a file location 402, a file name 403, and image information 404. Further, the image information 404 is managed based on a thumbnail image ID 405, a number of pages 406, a page size 407, and an image orientation 408.

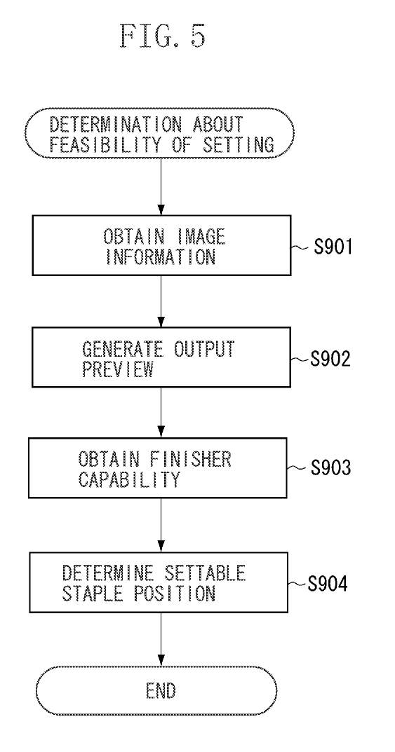

FIG. 5 is a flowchart illustrating an example of a data processing procedure performed by the image forming apparatus according to the present exemplary embodiment. This is an example of processing for generating an output preview with use of the thumbnail image information in the MFP 100. This processing includes steps S901 to S904. The CPU 101 loads the control program to the RAM 102 and executes it to realize steps S901 to S904. First, in step S901, the CPU 101 obtains the image information and the thumbnail image information corresponding to the document information for which an output preview is generated from the area storing them, by referring to the image data management table 400 in FIG. 4. Then, in step S902, the CPU 101 reflects the print settings specified by a user into the obtained thumbnail image, and generates an output preview on the RAM 102. Then, in step S903, the CPU 101 obtains information regarding the capability of the finisher unit 126 mounted on the MFP 100.

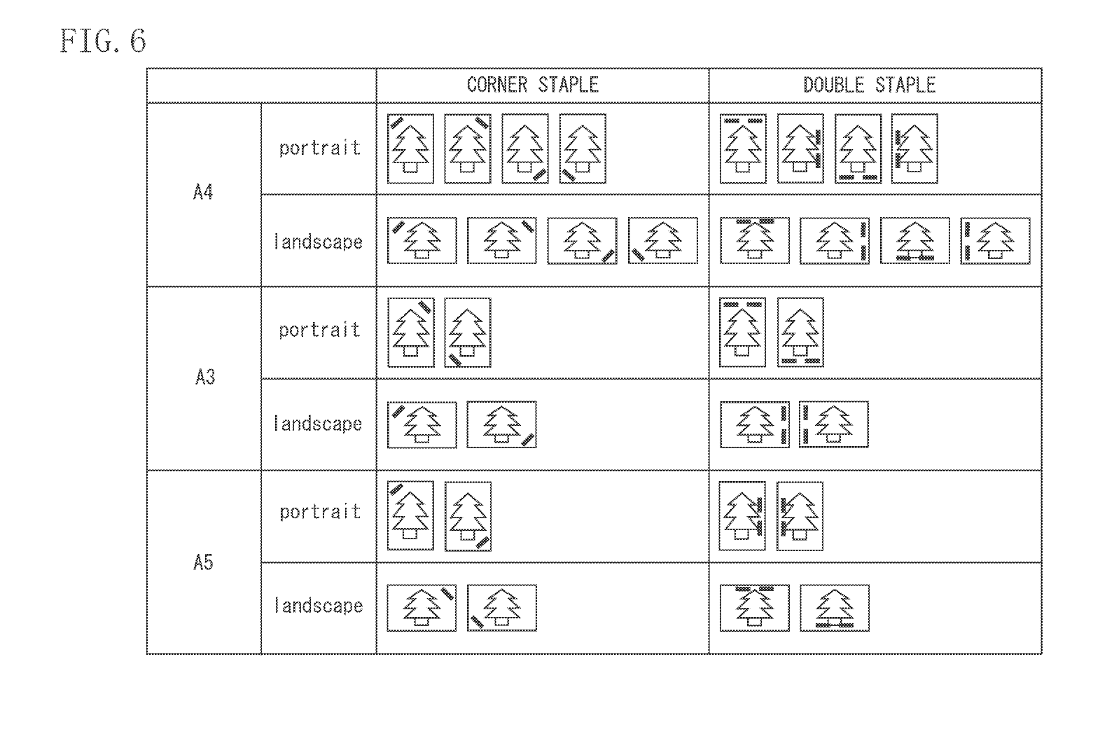

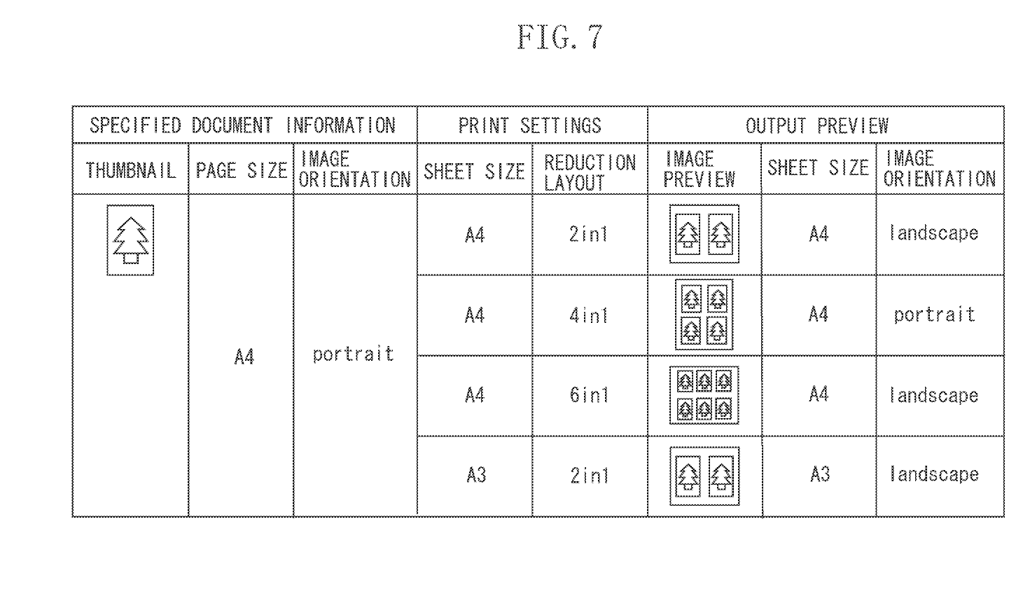

In the present exemplary embodiment, the stapling unit 248 included in the finisher unit 126 can apply “corner staple”, i.e., stapling the rear-side position or the front-side position at the trailing edge of sheets, and “double staple”, i.e., stapling two positions at the trailing edge of sheets, as mentioned above. FIG. 6 illustrates an example of sheet sizes and possible staple positions for each of “corner staple” and “double staple”, as the information regarding the capability of the finisher unit 126. Then, in step S904, the CPU 101 determines the settable staple position based on the output preview generated in step S902 and the information regarding the capability of the finisher unit 126 obtained in step S903, and ends the processing. FIG. 7 illustrates an example of the image preview generated based on the thumbnail image information and the document information obtained in step S901 and the specified print settings.

FIG. 7 illustrates an example of the image preview generated in the image forming apparatus according to the present exemplary embodiment. This example is constituted by specified document information, print settings, and output previews. In the present exemplary embodiment, since the output sheet size and the image orientation of the output preview are determined from the document information and the print settings illustrated in FIG. 7, the CPU 101 can determine the settable staple position based on the information regarding the capability of the finisher illustrated in FIG. 6.

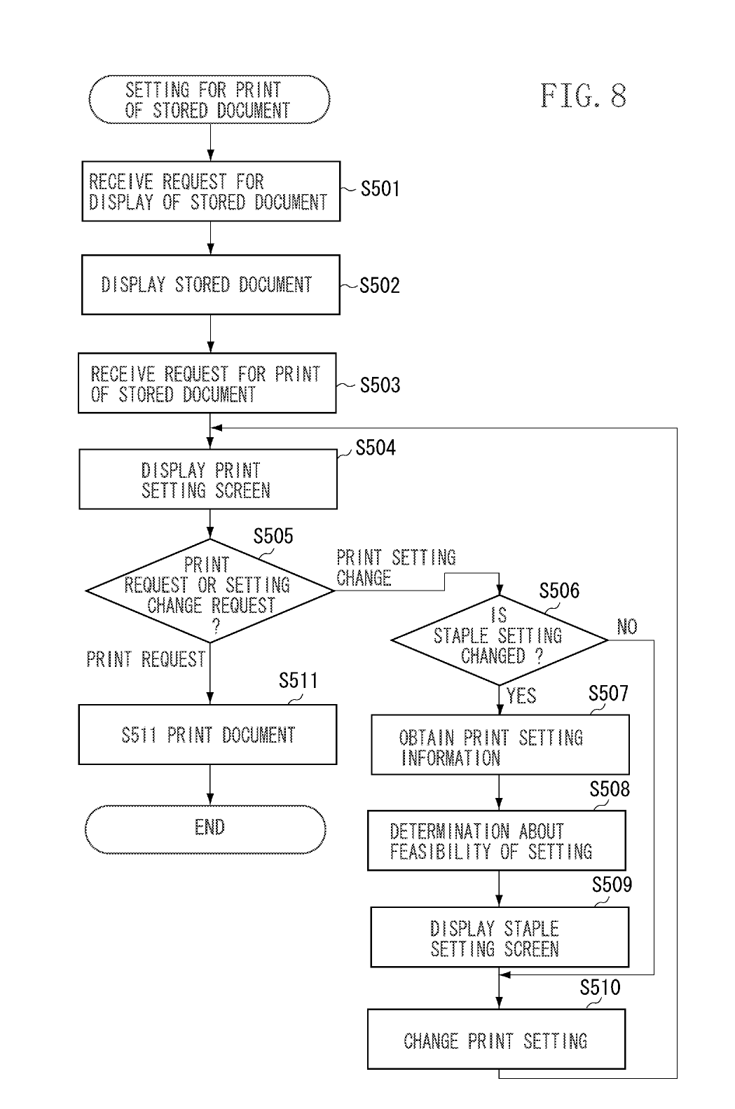

FIG. 8 is a flowchart illustrating an example of a data processing procedure performed by the image forming apparatus according to the present exemplary embodiment. This is an example of processing for performing print settings for printing a document stored in the HDD 104 in the MFP 100. This processing includes steps S501 to S511. The CPU 101 loads the control program to the RAM 102 and executes it to realize steps S501 to S511.

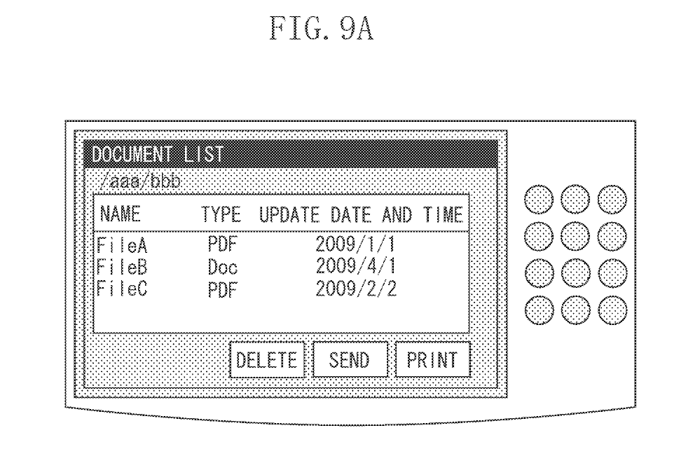

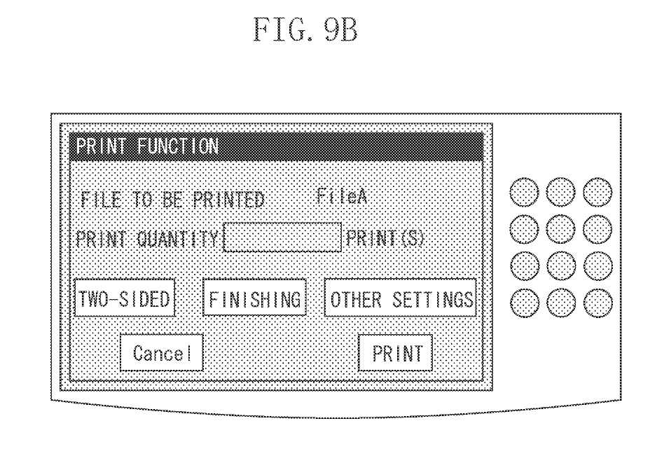

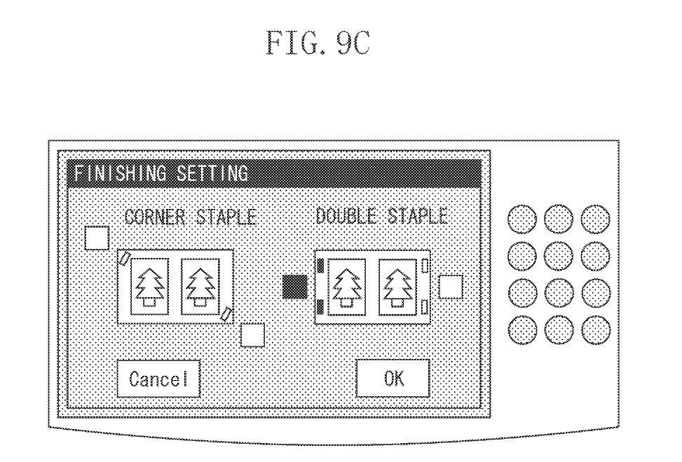

First, in step S501, the CPU 101 receives, through the operation unit I/F 105, a document list display request which a user inputs with use of the operation unit 121. After that, in step S502, the CPU 101 displays a stored document list in FIG. 9A on the operation unit 121. Then, in step S503, the CPU 101 receives, through the operation unit I/F 105, a print function request which the user inputs with use of the operation unit 121. After that, in step S504, the CPU 101 displays a print setting screen in FIG. 9B on the operation unit 121, and waits until receiving a next request. The user can select the settings of the print function such as the number of output prints, two-sided printing, and layout settings such as a reduction layout, and can issue a print request while checking the screen illustrated in FIG. 9B.

Then, in step S505, the CPU 101 receives, through the operation unit I/F 105, a request which the user inputs with use of the operation unit 121, and determines whether the received request is a print request or a print setting change request. If the CPU 101 determines in step S505 that the request received from the user is a print request (PRINT REQUEST in step S505), then the processing proceeds to step S511. On the other hand, if the CPU 101 determines in step S505 that the request received from the user is a print setting change request (PRINT SETTING CHANGE in step S505), then the processing proceeds to step S506 in which the CPU 101 further determines whether the received print setting change request is a request for changing the staple setting. If the CPU 101 determines in step S506 that the received request is not a request for changing the staple setting (NO in step S506), the processing proceeds to step S510.

On the other hand, if the CPU 101 determines in step S506 that the received request is a request for changing the staple setting (YES in step S506), the processing proceeds to step S507 in which the CPU 101 obtains the set print setting information. Then, in step S508, the CPU 101 determines whether the setting based on the obtained print setting information is feasible by referring to, for example, the information regarding the capability of the finisher in FIG. 6, and then obtains the settable staple positions. Subsequently, in step S509, the CPU 101 displays the obtained settable staple positions on a staple setting screen in FIG. 9C. For example, the output preview to be displayed on the staple setting screen in FIG. 9C is determined to have the A3 size and the landscape layout when the following print settings are applied to a document with the A4 size and the portrait layout, as illustrated in FIG. 7; that is, the print settings contain the 2-in-1 reduction layout and the A3 output sheet size. Further, as illustrated in FIG. 6, the stapling unit 248 included in the finisher unit 126 has a limitation to settable staple positions for a print with the A3 size and the landscape layout. More specifically, the staple positions are limited to up to two positions at the short side of an output sheet.

Therefore, the staple setting screen as illustrated in FIG. 9C is displayed as a display screen on which the user can specify only a settable position. At this time, the preview image is displayed along with the actual print image that is rasterized from the PDF file or XPS file and registered in advance. Then, in step S510, the CPU 101 receives, through the operation unit I/F 105, a request which the user issues with use of the operation unit 121, and changes the print settings based on the request. After that, the processing returns to step S504. On the other hand, if the CPU 101 determines instep S505 that the received request is a print request, the processing proceeds to step S511 in which the CPU 101 issues a print start request to the printer unit 123 through the printer I/F 118, and then ends the present processing. Upon receiving the print start request, the printer unit 123 starts printing the image according to the specified print settings. According to the present exemplary embodiment, it is possible to determine whether a setting is feasible with use of a thumbnail image generated in advance when a document is stored, whereby it is possible to prevent a user from selecting a setting that is infeasible due to the limitation of the capability of the finisher.

Further, since an output image preview in which the print settings are reflected can be displayed along with an image to be actually printed, a user can visually confirm the print settings. Further, since the processing of generating an image for a preview is not carried out when a print setting is changed, an output preview can be quickly displayed, and a setting change made by a user can be quickly reflected into the output preview.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable storage medium). In such a case, the system or apparatus, and the recording medium where the program is stored, are included as being within the scope of the present invention

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-296515 filed Dec. 26, 2009, which is hereby incorporated by reference herein in its entirety.

What is claimed is:

1. A printing apparatus capable of connecting to a post-processing apparatus for performing post-processing on a printed sheet, the printing apparatus comprising:
a storage unit configured to store document information of which file format is a predetermined file format;
a generating unit configured to generate an image corresponding to the document information by analyzing the document information stored in the storage unit;
a determining unit configured to determine a size of the sheet on which the image is printed;
an obtaining unit configured to obtain a capability of the post-processing apparatus; and
a control unit configured to display a settable post-processing position on a display unit according to the size of the sheet determined by the determining unit, and the capability of the post-processing apparatus obtained by the obtaining unit.

2. The printing apparatus according to claim 1, wherein the control unit displays the image generated by the generating unit and the settable post-processing position on the display unit.

3. The printing apparatus according to claim 1, wherein the generating unit generates the image corresponding to the document information in response to receiving the document information.

4. The printing apparatus according to claim 1, further comprising:
an accepting unit configured to accept a setting of the post-processing position from a user, after the settable post-processing position is displayed on the display unit.

5. The printing apparatus according to claim 1, further comprising:
a layout setting unit configured to set a layout of the image to be printed on one sheet
wherein the control unit displays the settable post-processing position on the display unit according to an orientation of the image generated by the generating unit, the size of the sheet determined by the determining unit, the capability of the post-processing apparatus obtained by the obtaining unit, and the setting of the layout set by the layout setting unit.

6. The printing apparatus according to claim 1, wherein the predetermined file format is the PDF format or XPS format.

7. A control method for controlling a printing apparatus capable of connecting to a post-processing apparatus for performing post-processing on a printed sheet, the control method comprising:
storing, into a storage unit, document information of which file format is a predetermined file format;
generating an image corresponding to the document information by analyzing the stored document information;
determining a size of the sheet on which the image is printed;
obtaining a capability of the post-processing apparatus; and
displaying a settable post-processing position on a display unit according to the determined size of the sheet, and the obtained capability of the post-processing apparatus.

8. A computer readable storage medium storing a computer-readable process, the computer-readable process causing a computer to perform a control method for controlling a printing apparatus capable of connecting to a post-processing apparatus for performing post-processing on a printed sheet, the control method comprising:
storing, into a storage unit, document information of which file format is a predetermined file format;
generating an image corresponding to the document information by analyzing the stored document information;
determining a size of the sheet on which the image is printed;
obtaining a capability of the post-processing apparatus; and
displaying a settable post-processing position on a display unit according to the determined size of the sheet, and the obtained capability of the post-processing apparatus.
